(19) United States
(12) Patent Application Publication
(10) Pub. No.: US 2026/0044803 A1
(43) Pub. Date: Feb. 12, 2026

(54) MULTIVARIABLE SERVICE TERMINATION RISK CLASSIFICATION USING MACHINE LEARNING

(71) Applicant: T-Mobile USA, Inc., Bellevue, WA (US)

(72) Inventors: Charalampos Dimitrakopoulos, Irvine, CA (US); Vivek Kurisunkal, Kirkland, WA (US); Leandro Lacorte Recova, Chino, CA (US); Ivan Octavio Vega, Concord, CA (US)

(21) Appl. No.: 18/797,308

(22) Filed: Aug. 7, 2024

(51) Int. Cl. G06Q 10/0635; G06N 5/01; G06N 20/20

(52) U.S. Cl. CPC G06Q 10/0635; G06N 5/01; G06N 20/20; G06Q 30/020122

(57) ABSTRACT

A method can include receiving input data comprising a plurality of features for a plurality of users. A method can including providing the input data to a risk prediction model configured to predict a termination likelihood for each user. In some implementations, the risk prediction model can be a random forest model. A method can include identifying, based on the predicted termination likelihood for each user, an at risk population including users with a termination risk above a threshold amount. A method can include determining, for each user of the at risk population, a profile type of a plurality of profile types. The profile type can describe certain attributes of the user. In some implementations, an end user can select a profile type. A method can include outputting members of the at risk population having the selected profile type.

### BACKGROUND

Acquiring new subscribers for a service provider can be a difficult and expensive process. For example, a company can spend significant money on advertising to reach new subscribers. Once interested individuals are found, converting them to subscribers can also have significant costs. For example, equipment (e.g., a smartphone, router, gateway, etc.) may need to be provided to the subscriber, a new subscriber may require significant support when getting started with a new service (e.g., hardware setup, number porting, etc.), and so forth.

On the other hand, existing subscribers may typically, though not always, incur lower costs for a service provider. For example, existing subscribers may contact support less frequently, have fewer questions, tend to pay their bills on time, and so forth. Thus, it can be important to retain existing subscribers.

Subscribers can discontinue a service for a wide variety of reasons. It can be significant to identify subscribers at risk of terminating services. One approach to retaining subscribers can be to look at subscriber feedback. For example, subscribers can provide feedback in the form of surveys, reviews, customer support interactions, and so forth. However, the subscribers may not communicate with a service provider about why they are terminating the service and may not reach out to the service provider before deciding to terminate the service.

Accordingly, there is a need for improved approaches to identifying subscribers who are at risk of churn.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example process for identifying at-risk subscribers according to some implementations.

FIG. 4 is a block diagram that illustrates an example process for training a machine learning model according to some implementations.

FIG. 5 is a block diagram that illustrates an example process for identifying an at-risk population according to some implementations.

FIG. 6 is a diagram that illustrates an example random forest according to some implementations.

FIG. 7 is a diagram that illustrates an example ensemble classifier training process according to some implementations.

FIG. 8 is a block diagram that illustrates an example training process according to some implementations.

FIG. 9 is a diagram that illustrates an example of applying a risk prediction model according to some implementations.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Limiting subscriber churn (e.g., termination of service) can be important for the success of a wireless telecommunications provider or any other company that relies on a subscription model. Significant expenses can be incurred in obtaining new subscribers (also referred to herein as users) (e.g., marketing expenses, promotional offer costs, equipment costs, initial setup support, etc.). If subscribers leave soon after beginning service, the wireless telecommunications provider may not recoup the expenses. Accordingly, it can be significant to identify at-risk subscribers before they terminate service. For example, if at-risk subscribers are identified before they have decided to terminate service, the wireless telecommunications provider can determine one or more treatments (e.g., service discounts, device discounts, promotional offers, etc.) to retain the subscriber.

While it can be important to identify at-risk subscribers, treatments, or both, it can be difficult to identify at-risk subscribers. Subscribers can leave for a wide variety of reasons, such as cost, coverage, competitor offers, billing issues, customer service problems, device age, and so forth. In some cases, there may not be a clear reason or reasons why a subscriber elects to terminate service. For example, a subscriber may switch services simply out of a desire to try out a different service, based on recommendations from friends or family, based on an upcoming move that is unknown to the wireless telecommunications provider, travel plans that are unknown to the wireless telecommunications subscriber, and so forth.

In some cases, a subscriber may reach out to support regarding service issues, billing issues, and so forth. If a subscriber does reach out to the wireless telecommunications company, these subscriber interactions can provide a good indication that the subscriber is at risk of churn and can provide a good indication of why the subscriber is at risk. However, it can be relatively rare that a subscriber contacts the wireless telecommunications provider prior to terminating service. Accordingly, there is a need for approaches that can identify subscribers at risk of terminating service without reliance on customer interactions with those specific subscribers or, in some cases, without reliance on customer service interaction information at all, though in some cases such information can be used as inputs when identifying subscribers at risk of terminating service.

While many factors may cause a subscriber to be at greater risk of terminating service, some factors may make a subscriber less likely to churn. For example, subscribers may remain with a wireless telecommunications provider because they receive good coverage, find the costs competitive, take advantage of certain promotions or offers (e.g., pay over time for a device, free device with subscription, discounted device with subscription, etc.), and so forth. In some cases, a subscriber may take advantage of certain partnerships between the wireless telecommunications provider and other companies. Such partnerships may provide subscribers with, for example, free or discounted video streaming services, music streaming services, cloud storage, in-flight Wi-Fi access, and so forth. Subscribers who take advantage of these partnerships may be less likely to switch service providers, may take the costs of replacing these services into consideration when considering switching, and so forth.

There is a need for approaches that can identify subscribers at risk of churn based on a wide range of varying and complex information. In some implementations, a machine learning model can be trained to identify subscribers who are at risk of terminating service.

Various types of machine learning models can be used in some implementations described herein. A "model," as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, a model can be a neural network with multiple input nodes. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, ("the output layer") one or more nodes can produce a value classifying the input. For example, as described herein, output values of a model a model can be used in determining whether a subscriber is at risk of churn, classifying subscribers into profiles, and so forth. In some implementations, such neural networks, known as deep neural networks, can have multiple layers of intermediate nodes with different configurations, can be a combination of models that receive different parts of the input and/or input from other parts of the deep neural network, or are convolutions - partially using output from previous iterations of applying the model as further input to produce results for the current input.

A machine learning model can be trained with supervised learning, where the training data includes subscriber information as input and a desired output, such as profile or risk of churn. A representation of the subscriber information can be provided to the model. Output from the model can be compared to the desired output and, based on the comparison, the model can be modified, such as by changing weights between nodes of the neural network or parameters of the functions used at each node (e.g., applying a loss function). After applying each of the subscribers in the training data and modifying the model in this manner, the model can be trained to evaluate different subscribers.

The most important features for predicting a churn can vary based on region or engineering market. For example, subscribers in a region or engineering market with many densely populated areas may be more likely to leave based on competitor offers, coverage inside buildings, capacity during periods of relatively high load, and so forth, while subscribers in a largely rural region may be more likely to leave based on coverage or data speeds in more remote areas. In rural areas, there can be significant gaps in coverage, for example due to the distance between cell sites, obstacles such as hills, and so forth. Rural subscribers may be more likely to regularly travel long distances for work, shopping, etc., and may switch providers based at least in part on coverage along one or more frequently-traveled routes. For example, a rural subscriber may have good coverage both at home and at work, but the subscriber may still be inclined to switch providers because of weak or non-existent coverage along the subscriber’s route to work.

A risk classification system can consider various inputs for determining a likelihood of churn. For example, a risk classification system can use subscriber attribute data, population data, competitiveness data, historical churn data, market type data, network quality data, subscriber-specific network quality data, technology type data, and/or additional data. Subscriber attribute data can include, for example, duration (e.g., time with service), age, credit score, income, data usage, data usage trends, voice usage, voice usage trends, travel patterns, usage locations, and so forth. Population data can include, for example, population in an area (e.g., within a zip code, within a metropolitan area, within an engineering segment, within a census block, etc.), adjusted gross income (AGI) in an area, and so forth. Competitor data can include information about competition within an area. Competitiveness data can include information about, for example, speed, coverage, and/or pricing of other wireless telecommunications services. In some implementations, competitiveness data can include information about promotions being offered by one or more competitors. Historical churn data can include historical churn rates within an area. Market type can indicate, for example, whether a market is a large metro area, small metro area, rural area, and so forth. Network quality data can include data about the overall quality of a network in a given area. For example, network quality data can include data relating to capacity, throughput, coverage, outages, congestion, and/or the like. Subscriber-specific network quality data can be data related to the network performance experienced by a subscriber. Subscriber-specific network quality data can include, for example, number of dropped calls, number of failed connections, dropped call frequency, failed connection frequency, average speed, incidents of roaming, and so forth. Technology type data can indicate what communications technology the subscriber is using. For example, technology type data can indicate if a subscriber is using 4G or 5G equipment.

In some cases, not all data that can be used as inputs to the risk classification model may be available. For example, certain network quality data may not be available for certain subscribers. The risk classification model can operate without the missing data by, for instance, not classifying subscribers for whom certain data is missing. For example, the risk classification model can be configured not to consider subscribers for whom data that more strongly indicates a likelihood of churn is missing or otherwise unavailable.

In some implementations, other data types can be used additionally or alternatively. For example, in some implementations, a risk classification model can consider partnership data, such as partnerships with streaming service providers, cloud services providers, in-flight Wi-Fi providers, restaurants, and so forth. If a subscriber takes advantage of such partnerships, they may be less likely to churn than a similar subscriber who does not take advantage of such partnerships.

Various types of models and training approaches can be used to determine termination risk or to classify users as either at risk of termination or not at risk of termination. For example, in some implementations, a model can be a linear regression model, decision tree model, random forest model, etc.

A logistic regression model is a linear model that can be used for classification tasks (e.g., binary classification tasks). The logistic regression model can predict the probability that an instance belongs to a particular class, for example, by applying a logistic function to a linear combination of input features. In some implementations, logistic regression models are optimized using techniques such as gradient descent. Logistic regression models can, in some cases, be relatively simple and interpretable, and can work well when there is an approximately linear relationship between features and a target variable such as risk of churn, but may perform poorly if there are non-linear relationships.

Stochastic gradient approaches can be used to train various types of machine learning models, such as logistic regression models. Stochastic gradient approaches iteratively update model parameters using the gradient of a loss function with respect to the parameters, for example, as calculated using a subset of training data. Stochastic gradient approaches can be well-suited for large datasets as data is processed in smaller subsets for training. However, stochastic gradient approaches can be sensitive to the learning rate and can require extensive tuning in order to perform well.

In some implementations, a random forest model can be used to make predictions, such as a likelihood of churn. A random forest can include a plurality of decision trees and can be trained using ensemble learning methods. Each decision tree can output a prediction, and the individual predictions of each decision tree can be aggregated to determine a result of the random forest model. For example, the output of a random forest model can be the mode of the classifications (e.g., majority vote) of the decision trees or the average prediction of the individual decision trees in the random forest. In some implementations, the output can be a termination likelihood. In some embodiments, a user can be classified as at risk if the termination likelihood is above a threshold amount or if a majority vote indicates that the user is at risk of termination.

Different decision trees in a random forest can capture different aspects of input data. Accordingly, in some cases, random forests may be better suited to handling certain tasks, for example when there are non-linear relationships between features and target variables. Additionally, random forests can be less prone to overfitting than some other model types because, for example, individual decision trees within the random forest can be trained using different input features and may have a relatively small number of input features.

Ensemble learning is a machine learning technique that combines the predictions of multiple models. In some cases, such an approach can result in better predictive performance than some other learning methods. In ensemble learning, predictions from different models (e.g., models trained on different training data and/or trained using different features) are aggregated to achieve an overall result. Depending upon the particular implementation, the overall result can be determined by, for example, averaging outputs of multiple models, taking the mode of outputs from different models (e.g., voting), and so forth. In a random forest model, each decision tree of the random forest can be trained using different subsets of data and/or different subsets of features. In some implementations, the different subsets of data can be selected by random sampling. In some implementations, different subsets of features can be selected by random sampling. Sampling techniques are described in more detail herein. For example, in the context of churn risk modeling, the decision trees can be trained on different subsets of subscribers and different subsets of features, which can include, for example, tenure time, network performance, competitiveness data, and/or any other features as described herein.

Several approaches can be used in ensemble learning, including, for example, bagging, boosting, or stacking. In bagging (bootstrap aggregation), multiple instances of a model (e.g., a decision tree model) can be trained using different subsets of training data. The subsets can be selected from an overall training set. Typically, though not necessarily, selection is done with replacement. That is, the same item (e.g., the same subscriber) can appear in multiple subsets and/or can appear multiple times within the same subset. In some cases, a particular subscriber may not appear in any subset. Different subsets can include different features. For example, one subset can include network quality data, while another subset may not include network quality data but can include, for example, subscriber attribute data. In some implementations, each decision tree of the random forest can be built from a random subset of training data, a random subset of features, or both, which can help limit overfitting, improve generalization, and so forth.

Techniques such as bagging, boosting, and stacking can offer different benefits and tradeoffs. For example, as described herein, in a bagging approach, multiple training sets are generated from an original training set. The multiple training sets are typically generated by selection with replacement. In such an approach, the multiple training sets are created without regard for the content of previously-created training sets and without regard to the performance of a model trained using a previously-created training set. This can have an advantage in that information about prior performance is not needed to create subsequent training sets. In contrast, in a boosting approach, data sets are selected while accounting for previous model performance. In some implementations, in a bagging approach, given a training data set of size N, bagging can create a number M of new training data sets. In some implementations, the M new training data sets can each also be of size N.

Data preparation can have a significant impact on model performance (e.g., performance of a random forest model). In some implementations, a method can include various data preparation operation(s), such as transforming one or more features by one-hot encoding one or more features. This can help ensure that different inputs are comparable to each other, thereby avoiding having a single input with large values skew the input data or compromise results. One hot encoding can be used to transform categorical data into binary vectors. Each category can be represented by a unique binary vector with a single high (e.g., 1) bit while other bits are low (e.g., 0). As a simple example, categories of “red,” “green,” and “blue” can be represented as [001], [010]. and [100], respectively.

In some implementations, market type can be one-hot encoded. For example, if there are four market types (e.g., top 100, rural, county, small), the different markets can be one-hot encoded with four bits (e.g., 1000 for top 100, 0100 for rural, 0010 for county, and 0001 for small). In some implementations, values of certain input features can be binned and one-hot encoded. For example, credit scores can be binned into groups (e.g., prime, sub-prime, near-prime, other) and the bins can be encoded using one-hot encoding. Other variables can be similarly encoded, such as age, income level, tenure time, and so forth.

### Subscriber Profiling

As described herein, identifying at-risk subscribers can be beneficial as it can identify subscribers for whom outreach may be appropriate before they decide to discontinue service. However, it may be infeasible to reach out to every at-risk subscriber, and there may be limited options for preventing certain types of subscribers from discontinuing service. For example, if a subscriber accesses a wireless telecommunications network in an area with limited or spotty coverage, there may be little the wireless telecommunications network provider can do to prevent the subscriber from leaving, as doing so may require significant network upgrades that take considerable time and investment to deploy. In other cases, a subscriber may be more likely to leave because they have an outdated device (e.g., smartphone) and may switch carriers when they get a new device, for example because a competitor is offering a device promotion to people who switch. Such subscribers may be relatively easy to retain, for example by offering a discount on a new device or providing financing for a new device.

It can be advantageous to group at risk subscribers into profiles that share one or more common attributes, as these subscribers who share common attributes may be likely to respond to the same or similar efforts to retain them. Profiles can help to identify groups of subscribers for retention efforts, to identify types of subscribers who are more likely to terminate service, etc.

In some implementations, profiles can be associated with subscribers. Profiles can group subscribers together based on one or more similarities. Profiles can include, for example, subscribers where there is a known coverage or competitiveness issue, subscribers who have favorable coverage or competitiveness but who have an older device (e.g., a 4G smartphone), subscribers who have good coverage but have been with the carrier for a short amount of time (e.g., less than six months), and/or subscribers who have good coverage and have been with the carrier for a longer amount of time (e.g., longer than six months). These are merely examples, and other profiles are possible. For example, in some cases, a wireless telecommunications company may want to have separate profiles for subscribers where coverage issues are identified and subscribers where competitiveness issues are identified, for example because a competitiveness issue (e.g., price, speed, etc.) can be easier to remediate than a coverage issue, which can require network reconfiguration or upgrades, such as the deployment of additional cell sites or the upgrading of existing cell sites.

In some implementations, a churn prediction system can select only users matching certain profiles, and those subscribers can be identified for outreach. In some implementations, the churn prediction system can identify specific recommended actions to limit churn, or subscriber information can be provided to another model to generate recommended treatments to limit churn.

In some implementations, the churn prediction system can select those subscribers having a profile that is most likely to churn. In some implementations, the churn prediction system can select those subscribers having a profile associated with a greatest likelihood of success in preventing churn. For example, it may be relatively easy to reduce churn among subscribers who have older devices by offering them newer devices.

As discussed herein, there can be significant differences in the reasons subscribers are likely to churn, and these reasons can vary by location (e.g., region, engineering market, etc.). In some implementations, which profile or profiles are selected for outreach or other churn mitigation efforts can vary based on region, engineering market, etc. Such an approach can result in more effective outreach to at risk subscribers and better use of limited resources for preventing or limiting churn. Moreover, reasons subscribers are likely to churn, likely effective mitigation efforts, and so forth can vary over time. For example, risk of churn and effective mitigations can change depending on promotions, network upgrades, etc., offered by a subscriber’s current wireless telecommunications service and competitor telecommunications services.

Profiles can be created in a variety of ways. For example, in some implementations, profiles are defined manually, for example based on analysis of different groups of users and their likelihood of terminating service. However, such an approach can be laborious and can miss features in data that are relevant for identifying subscribers who are at risk or subscribers for whom retention efforts are more or less likely to be successful. In some embodiments, a machine learning model, such as a clustering model or classification model, can be used to group similar users into various profiles.

Clustering models can be used to group users into a plurality of groups that share common characteristics. In some implementations, centroid-based clustering approaches, such as K-means clustering, are used to cluster users. In K-means clustering, a predetermined number of clusters (K) is defined and users are assigned to a closest centroid. Centroids can be placed within a data space, and can be iteratively repositioned based on assigned users, eventually converging upon a stable set of clusters.

Feature selection can play an important role in k-means clustering. For example, if irrelevant features are selected, users can be clustered according to the selected features, but the clusters may not provide meaningful information that can be used for determining which at-risk subscribers to target for retention efforts.

K-means clustering is merely one example, and other clustering or classification models can be used for grouping subscribers.

### Wireless Communications System

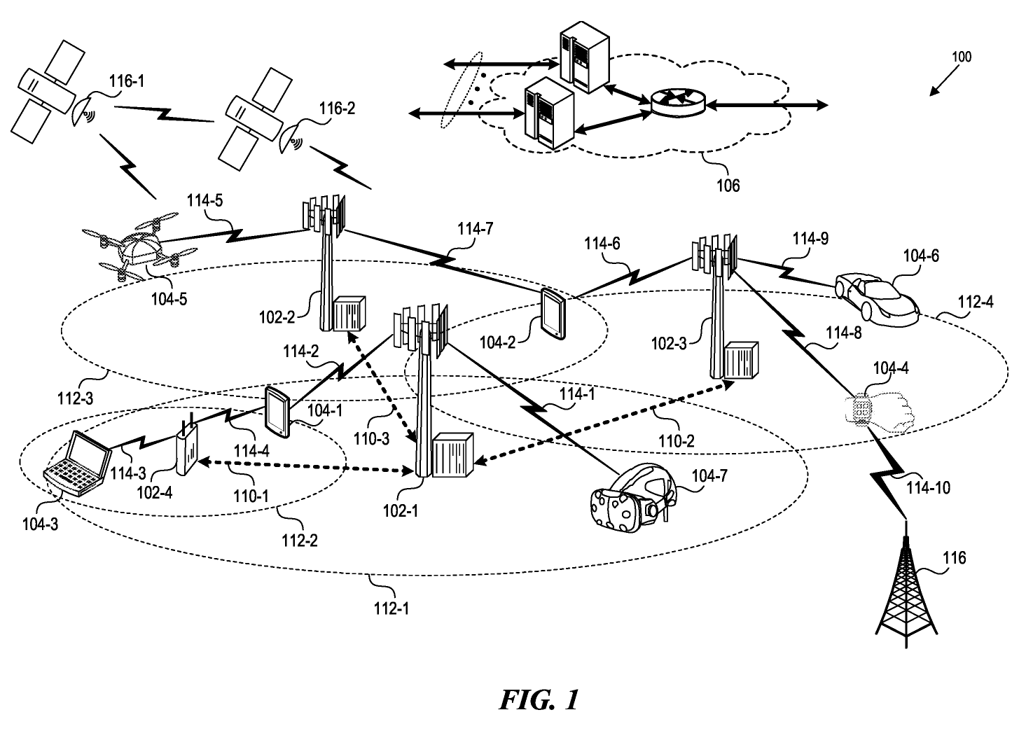

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

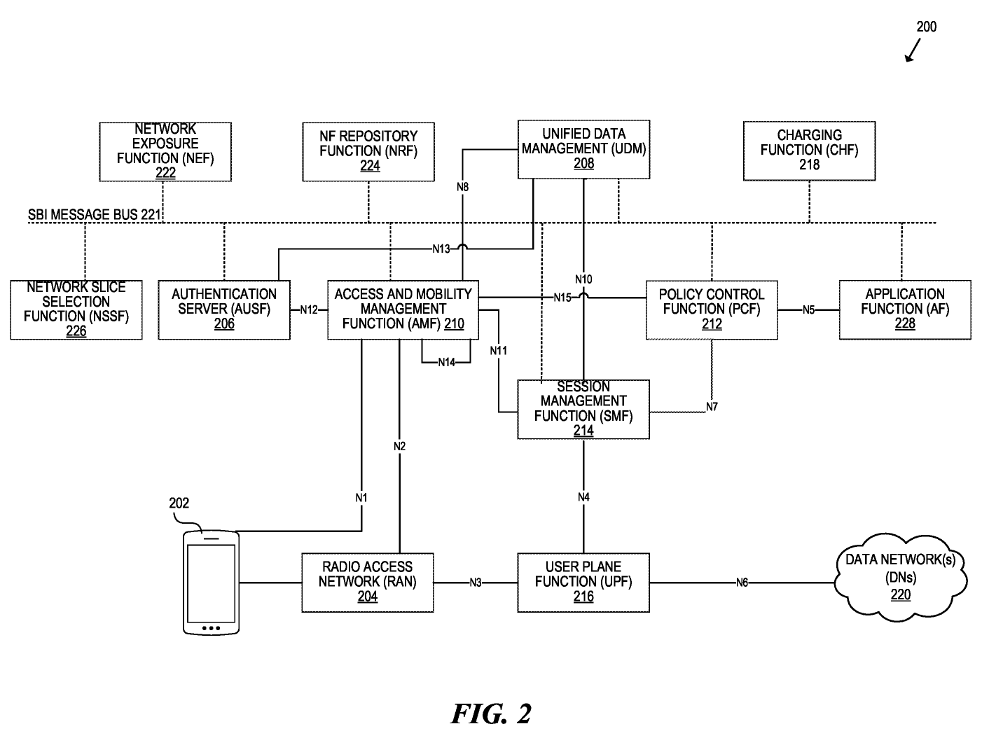

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Subscriber Churn Risk Identification

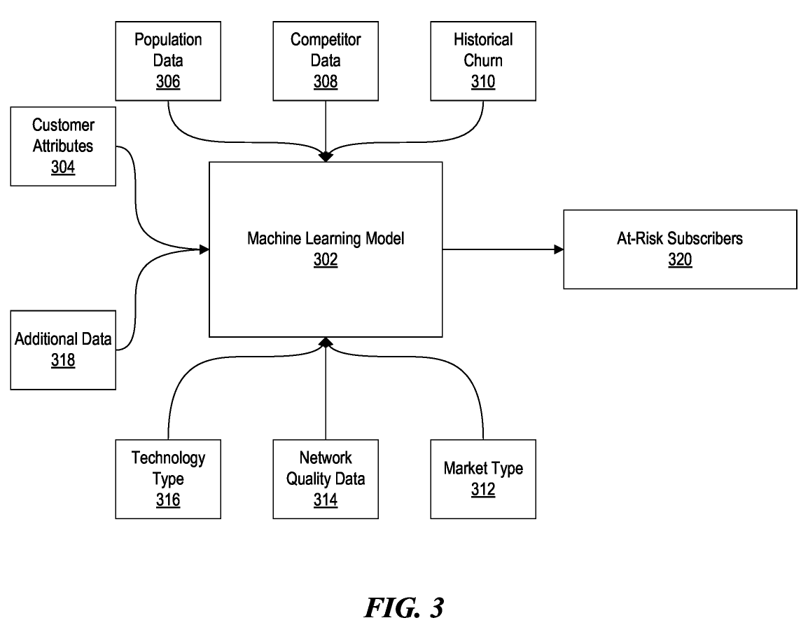

FIG. 3 is a block diagram that illustrates an example process for identifying at-risk subscribers according to some implementations. A machine learning model 302 can receive multiple inputs that can be used to predict a subscriber’s risk of churn. For example, the machine learning model 302 can receive customer attribute data 304, population data 306, competitor data 308, historical churn data 310, market type data 312, network quality data 314, technology type data 316, and/or additional data 318. A system (e.g., a computer system) can apply the machine learning model 302 to the data to predict at-risk subscribers 320.

In some implementations, the machine learning model 302 can be trained using supervised learning. For example, training data can comprise any of the types of input data 304-318, and the training data can be labeled to indicate whether a subscriber was at-risk or not, for example based on whether or not the subscriber terminated service. The training data can include data from a first time period and a termination status (e.g., terminated or not terminated) from a second time period. The second time period can be after the first time period. As an example, data from two months in the past can be labeled with a termination status from the present time. Such an approach is beneficial as it provides information about the subscribers at a time leading up to their decision to terminate or stay with the service.

In some implementations, the machine learning model 302 is a random forest model that includes a plurality of decision trees, and each decision tree can receive a portion of the inputs and output a determination of whether or not a corresponding subscriber is at risk of terminating service.

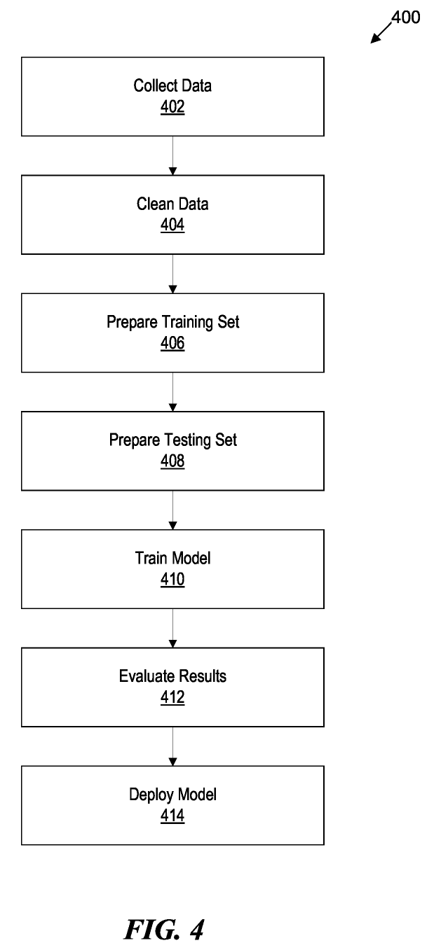

FIG. 4 is a block diagram that illustrates an example process for training a machine learning model according to some implementations. the process 400 can be performed on a computer system. At operation 402, the system can collect data, for example subscriber attribute data, population data, competitor data, historical churn data, market type data, network quality data, technology type data, and/or other data. Input data can be collected from a variety of sources, which can be any combination of public sources, private sources, or both. For example, subscriber attribute data can be stored in a database that tracks sign up dates, credit scores, and so forth. In some cases, subscriber data is distributed across multiple databases. For example, duration data can be stored in a private source (e.g., a company’s internal database) while credit score data, age, income, etc., can be stored in one or more third party data sources or can be stored in a company-controlled database after being retrieved from a third party source. As another example, network quality data can be stored in one or more databases, such as engineering databases used for network operations or planning. At operation 404, the system can clean the data. For example, empty values can be removed, categorical values can be one-hot encoded, numerical values can be binned and one-hot encoded, data such as dates can be reformatted to confirm with a particular format, and so forth. At operation 406, the system can prepare a training set. The training set can be, for example, a subset of the collected and cleaned data. At operation 408, the system can prepare a testing set. The testing set can be, for example, a subset of the collected and cleaned data. In some implementations, the testing set includes data not included in the training set. At operation 410, the system can train the model using the training set. In the case of a random forest made up of decision trees, each decision tree can be trained.

Recursive partitioning can be used in training a decision tree. Training each decision tree can include searching for a best feature of a plurality of features in the training data, where the best feature is a feature that creates two subsets that are as different as possible in terms of the target variable (e.g., risk of terminating service). This process can continue for each level of a decision tree. Splits can be evaluated using various metrics, such as information gain, Gini impurity, or mean square error. In some implementations, the system uses information gain as a metric to evaluate splits, which measures how much a given split reduces uncertainty about a target variable. In some implementations, the system uses mean squared error as a metric, calculating the average squared difference between predicted and actual values after splitting. The system can select a best split based on the split that results in the highest information gain, the lowest Gini impurity, or the lowest mean squared error.

As an example, consider inputs that include network speed, dropped call rate, credit score, and device age. During training, a system may determine that network performance is the biggest differentiator between subscribers who are at risk and those who are not is dropped call rate, and the next biggest differentiator is network speed, followed by credit score and finally device age, thereby determining an order for the features to be considered by the decision tree.

The number of nodes in a decision tree can vary. In some implementations, the maximum depth of a tree is defined, which can help avoid overfitting. Alternatively or additionally, the number of nodes stops growing once all data points (e.g., users) in a node belong to the same class or there are no more informative splits to be made (e.g., there are no more features to consider, or the remaining features provide no additional information). At operation 412, the system can use the testing set to evaluate the model. Performance of the model on the testing set can indicate if the model is generalized (e.g., suitable for applying to new data that the model has not previously encountered), overfit to the training data, or insufficiently trained to make generalized prediction (e.g., because the training dataset was too small or had insufficient variation in feature values). At operation 414, the system can deploy the model for use on new data., for example after determining that the model meets one or more performance criteria, such as a metric that characterizes how often the model makes correct classifications, makes incorrect classifications, etc.

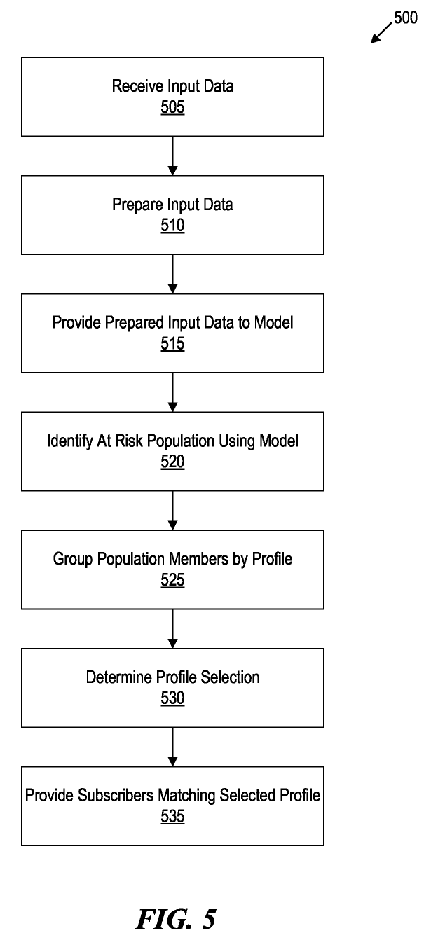

FIG. 5 is a block diagram that illustrates an example process for identifying an at-risk population according to some implementations. The process 500 can be performed by a computer system. At operation 505, the system can receive input data, for example input data as described herein. At operation 510, the system can prepare the input data, for example by removing null values, encoding variables, and so forth. At operation 515, the system can provide the prepared input data to a machine learning model (which, in some implementations, can be an ensemble of models, such as a random forest made up of decision trees). At operation 520, the system can, using the machine learning model, identify an at-risk population. At operation 525, the system can group members of the at-risk population by profile, for example by assigning the members of the at-risk population to pre-defined groups based on one or more characteristics of each member (e.g., tenure, coverage, competitiveness, etc.). In some implementations, the system can group members using a machine learning model, such as a classification model or clustering model configured to group members based on one or more characteristics. At operation 530, the system can determine a profile selection. In some implementations the system can determine the profile selection by receiving an input from a user that identifies a profile. In some implementations, the system can automatically determine the profile. For example, in some implementations, a profile with the most at-risk members can be selected. In some implementations, profiles may have a mitigation difficulty ranking associated therewith, and the system can select a profile based at least in part on the mitigation difficulty ranking. For example, profiles with lower mitigation difficulty rankings (indicating easier or likely more effective mitigation) can be selected preferentially over profiles with higher mitigation difficulty rankings. The mitigation difficulty ranking can be based on various factors. For example, in some implementations, mitigation difficulty ranking is based on historical success at reducing churn rate by engaging in retention efforts with subscribers within a profile. In some implementations, mitigation difficulty ranking is based on cost of retention efforts, feasibility of retention efforts, etc.

In some implementations, multiple profiles can be selected. For example, in some implementations, a user input can indicate a selection of two or more profiles. In some implementations, a system can automatically select profiles until a desired population size is reached, for example, by selecting users with a profile with easiest or most successful retention efforts, then selecting progressively more difficult profiles until a desired population size is reached. At operation 535, the system can make the subscribers matching the selected profile available. For example, the system can generate a list of subscribers matching the profile which can be stored in a file, stored in a database, emailed, displayed on a screen, etc.

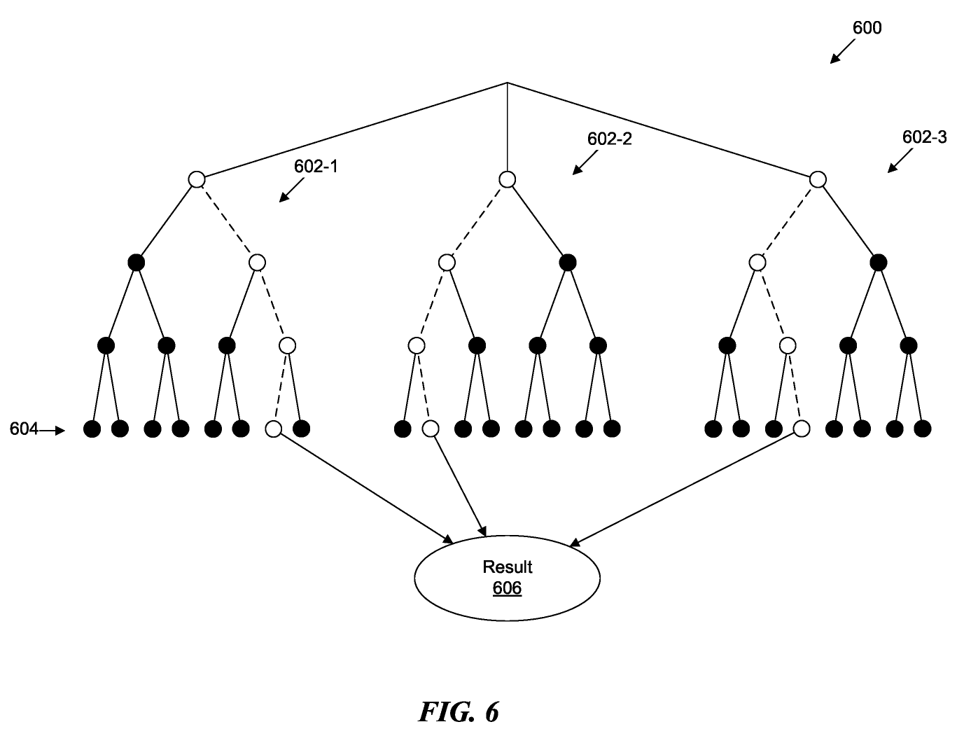

FIG. 6 is a diagram that illustrates an example random forest according to some implementations. The random forest 600 can include a plurality of decision trees, each decision tree having a plurality of nodes. In FIG. 6, three decision trees 602-1, 602-2, and 602-3, are illustrated. However, the number of decision trees included in the random forest 600 is not necessarily limited. Example paths through the decision trees are illustrated by open circles connected via dashed lines. The leaf nodes 604 can indicate the final results of each decision tree. The number of nodes in a decision tree is not necessarily limited. For example, there can be more or fewer nodes than illustrated in FIG. 6. In some implementations, a maximum depth for the decision trees can be provided when training a random forest model. Additionally, while each decision tree has the same number of nodes in FIG. 6, it will be appreciated that the number of nodes can vary, and different decision trees can have different numbers of nodes.

The results from the leaf nodes 604 can be evaluated to produce a result 606. In some implementations, for example, the result 606 can be obtained by averaging the results of each decision tree. In some implementations, the result 606 can be obtained by taking the mode of the results of each decision tree (e.g., voting).

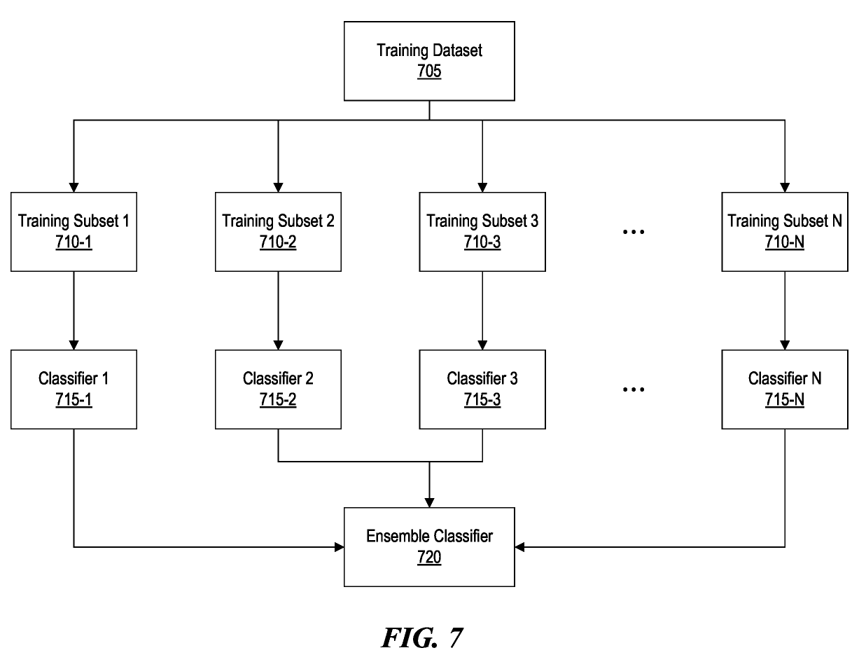

FIG. 7 is a diagram that illustrates an example ensemble classifier training process according to some implementations. A computer system can receive a training set 705. The computer system can, based on the training set 705, create training subsets 710-1 – 710-N. In some implementations, the training subsets can be created by randomly selecting objects from the training set 705 with replacement. That is, when an object is selected from the training set 705, the object is not removed from the training set 705 and is available to be selected in subsequently created training subsets or within the same subset. Thus, in some cases, different training subsets can include the same object, and the same object can appear more than once within a given training subset. In some implementations, the training subsets can include a subset of features, such that different classifiers are trained using different sets of features.

The classifiers 715-1 – 715-N, which can be, for example, random forests, can be trained using the training subsets 710-1 – 710-N. The outputs of the trained classifiers can be combined to determine a final output. The classifiers 715-1-715-N can collectively make up an ensemble classifier 720 (e.g., a random forest). The ensemble classifier 720 can determine a final output using the outputs of the classifiers 715-1 – 715-N, for example, by averaging the outputs of the classifiers 715-1 – 715-N, taking the mode of the outputs, etc.

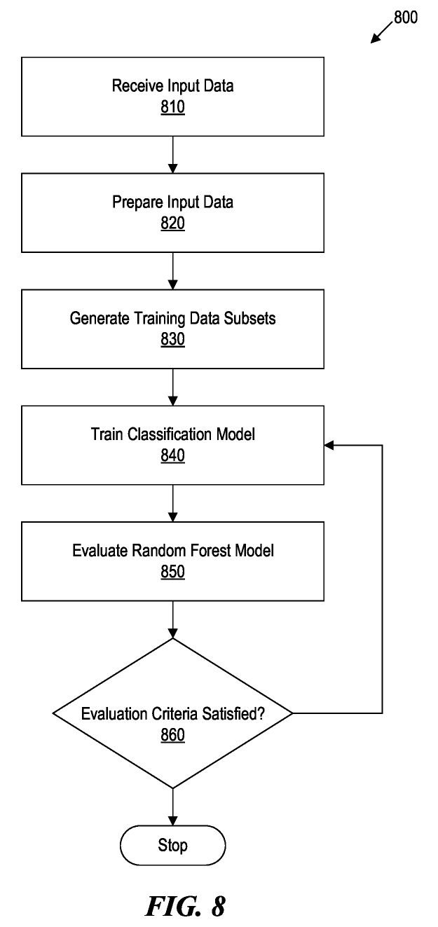

FIG. 8 is a block diagram that illustrates an example training process according to some implementations. The process 800 can be performed on a computer system. At operation 810, the system can receive input data. The input data can include, for example, subscriber attribute data, network quality data, competitor data, and/or any other data as described herein. In some implementations, the data can correspond to subscribers who terminated or did not terminate service. At operation 820, the system can prepare the input data for training. For example, null values can be dropped, data can be one-hot encoded, and so forth. At operation 830, the system can generate a plurality of training data subsets. In some implementations, the subsets can be selected with replacement. In some implementations, the subsets can include subsets of features. At operation 840, the system can train a classification model. In some implementations, the classification model is a random forest, and the system can train a plurality of decision tree models that make up the random forest. In some implementations, the training can be performed in a supervised manner, in which the models are trained to determine whether or not a subscriber terminated service. At operation 850, the system can evaluate the random forest model, for example using a testing dataset. At operation 860, if the random forest model meets one or more evaluation criteria (e.g., false positive rate, false negative rate, true positive rate, true negative rate, etc.), the training can stop. If not, the training can continue until the evaluation criteria are satisfied. In some cases, the evaluation criteria may not be satisfied but training may nonetheless stop after a maximum number of training iterations.

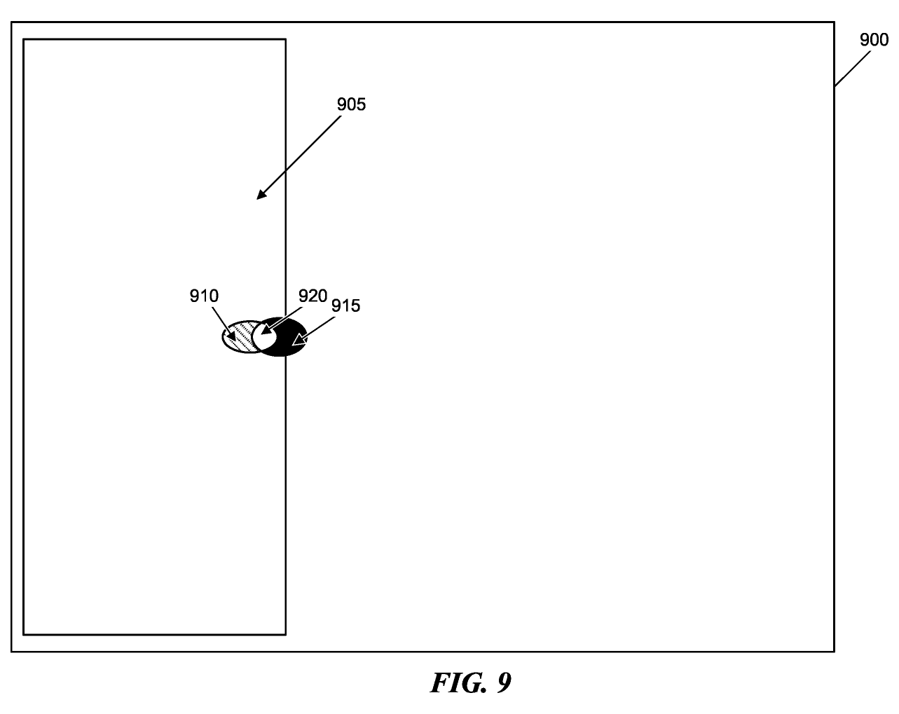

As described herein, in some cases, data for determining risk of churn may not be available for all subscribers. For example, certain network performance data may only be available for users with certain devices. FIG. 9 illustrates an example of applying a risk prediction model according to some implementations. Out of a total subscriber population 900, information for subpopulation 905 is available for churn risk prediction. For example, the subpopulation 905 can include subscribers for whom certain information required by the risk prediction model is available. The risk prediction model can analyze subscribers in the subpopulation 905 to identify an at risk population 910. Termination group 915 represents subscribers in the population 900 who terminated service. As shown in FIG. 9, the termination group 915 includes subscribers in the subpopulation 905 as well as subscribers outside the subpopulation 905. An overlap population 920 indicates those users in the termination group 915 and the at risk population 910 (i.e., those users who were identified as at risk and actually terminated service).

### Computer System

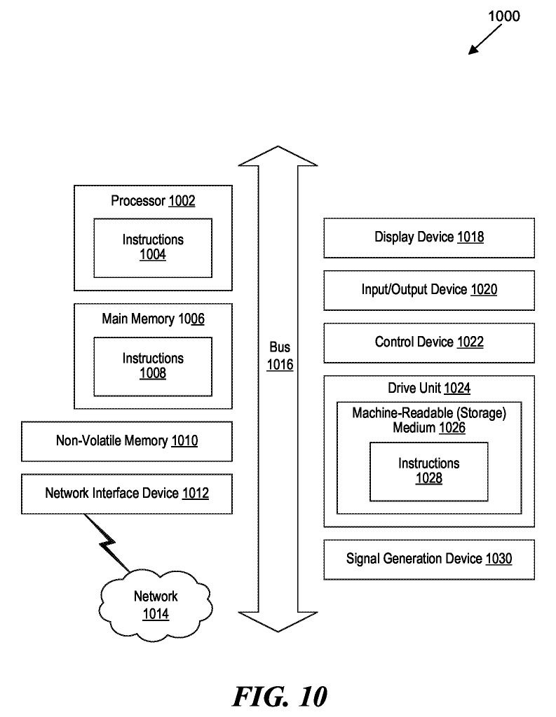

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A computer-implemented method for risk classification for wireless telecommunications network users using a risk prediction model, the computer-implemented method comprising:
receiving input data comprising a plurality of features for a plurality of subscribers of a telecommunications service provider, wherein the features comprise at least one of: network capacity data, network throughput data, network coverage data, network outage data, or network congestion data;
providing the input data to the risk prediction model, the risk prediction model trained to predict a termination likelihood for each subscriber of the plurality of subscribers,
wherein the risk prediction model comprises a random forest model;
identifying, based on the predicted termination likelihood for each subscriber, an at risk population comprising a subset of the plurality of subscribers having a termination likelihood above a threshold amount;
determining, for each subscriber of the at risk population, a profile type of a plurality of profile types, wherein determining the profile type comprises determining that one or more characteristics of each subscriber matches one or more characteristics of the profile type;
assigning the determined profile type to each subscriber of the at risk population;
determining a selection of a profile type; and
making available a subset of the at risk population having the selected profile.

2. The computer-implemented method of claim 1, wherein the risk prediction model comprises a plurality of decision trees, wherein each decision tree is trained by:
selecting a subset of training data from a training dataset; and
training the decision tree using the subset of training data, wherein training the decision tree comprises recursively partitioning the subset of training of training data,
wherein the recursive partitioning is based on at least one of Gini impurity or information gain.

3. The computer-implemented method of claim 2, wherein selecting a subset of data comprises selecting data from the training data set with replacement.

4. The computer-implemented method of claim 1, further comprising, prior to providing the input data to the risk prediction model:
transforming one or more items of the input data by one-hot encoding each of the one or more items.

5. The computer-implemented method of claim 1, wherein determining the selection of the profile type comprises receiving a selection from an operator of a profile type.

6. The computer-implemented method of claim 1, wherein determining the selection of the profile type comprises:
determining a selected profile type for each engineering segment of a plurality of engineering segments,
wherein making available the subset of the at risk population having the selected profile comprises making available a plurality of population subsets, each population subset corresponding to an engineering segment of the plurality of engineering segments, each population subset comprising a plurality of subscribers, wherein each subscriber of each population subset has the selected profile type for the corresponding engineering segment.

7. The computer-implemented method of claim 1, further comprising:
determining, based at least in part on the selected profile, a recommended action.

8. A computer-implemented method for training a random forest model for risk classification using an ensemble learning method, the computer-implemented method comprising:
receiving a dataset comprising a plurality of data points, each data point comprising a plurality of features;
creating, from the data, a plurality of subsets, wherein the plurality of subsets is created by random sampling of the data points and random sampling of the plurality of features;
generating a plurality of decision trees, each decision tree of the plurality of decision trees trained using a subset of the plurality of subsets; and
generating a random forest model by combining the plurality of decision trees,
wherein each data point corresponds to a subscriber of a wireless telecommunications service,
wherein each data point includes a label indicating if the subscriber terminated service, and
wherein training each decision tree is performed using supervised learning.

9. The computer-implemented method of claim 8, wherein the ensemble learning method is selected from bootstrap aggregation, boosting, or stacking.

10. The computer-implemented method of claim 8, wherein the random sampling comprises bootstrap aggregation.

11. The computer-implemented method of claim 8, wherein the plurality of subsets is created by random sampling with replacement.

12. The computer-implemented method of claim 11, wherein the data includes a first number of data points, and
where each subset of the plurality of subsets includes the first number of data points.

13. A system comprising:
at least one hardware processor; and
at least one non-transitory memory storing instructions, which, when executed by the at least one hardware processor, cause the system to:
receive input data comprising a plurality of features for a plurality of subscribers of a telecommunications service provider, wherein the features comprise at least one of: network capacity data, network throughput data, network coverage data, network outage data, or network congestion data;
provide the input data to a risk prediction model, the risk prediction model configured to predict a termination likelihood for each subscriber of the plurality of subscribers, wherein the risk prediction model comprises a random forest model;
identifying, based on the predicted termination likelihood for each subscriber, an at risk population comprising a subset of the plurality of subscribers having a termination likelihood above a threshold amount;
determining, for each subscriber of the at risk population, a profile type of a plurality of profile types;
assigning the determined profile type to each subscriber of the at risk population;
determining a selection of a profile type; and
making available a subset of the at risk population having the selected profile.

14. The system of claim 13, wherein the risk prediction model comprises a plurality of decision trees, wherein each decision tree is trained by:
selecting a subset of training data from a training dataset; and
training the decision tree using the subset of training data, wherein training the decision tree comprises recursively partitioning the subset of training data,
wherein the recursive partitioning is based on at least one of Gini impurity or information gain.

15. The system of claim 14, wherein selecting a subset of data comprises selecting data from the training data set with replacement.

16. The system of claim 13, further comprising, prior to providing the input data to the risk prediction model:
transforming one or more items of the input data by one-hot encoding each of the one or more items.

17. The system of claim 13, wherein determining the selection of the profile type comprises receiving a selection from an operator of a profile type.

18. The system of claim 13, wherein to determine the selection of the profile type, the instructions are configured to cause the system to:
determine a selected profile type for each engineering segment of a plurality of engineering segments,
wherein making available the subset of the at risk population having the selected profile comprises making available a plurality of population subsets, each population subset corresponding to an engineering segment of the plurality of engineering segments, wherein each user of each population subset has the selected profile type for the corresponding engineering segment.

19. The system of claim 13, where the instructions are further configured to cause the system to:
determine, based at least in part on the selected profile, a recommended action.

20. The system of claim 13, wherein to risk prediction model is a trained machine learning model, wherein the instructions further cause the system to train the risk prediction model by:
receiving a dataset comprising a plurality of data points, each data point comprising a plurality of features;
creating, from the data, a plurality of subsets, wherein the plurality of subsets is created by random sampling of the data points and random sampling of the plurality of features;
generating a plurality of decision trees, each decision tree of the plurality of decision trees corresponding to a subset of the plurality of subsets;
generating a random forest, wherein generating the random forest comprises combining the plurality of decision trees; and
training the random forest using an ensemble learning method,
wherein each data point corresponds to a subscriber of the telecommunications service provider.
